(19) United States
(12) Patent Application Publication
(10) Pub. No.: US 2005/0245240 A1
(43) Pub. Date: Nov. 3, 2005

(54) Apparatus and method for storing media during interruption of a media session

(76) Inventors: Senaka Balasuriya, Arlington Heights, IL (US); Brian K. Classon, Palatine, IL (US); David J. Krause, Hainesville, IL (US); Joseph R. Schumacher, Glen Ellyn, IL (US)

Correspondence Address: MOTOROLA INC, 600 NORTH US HIGHWAY 45, ROOM AS437, LIBERTYVILLE, IL, 60048-5343, US

(21) Appl. No.: 10/836,033

(22) Filed: Apr. 30, 2004

(51) Int. Cl. H04Q 7/00

(52) U.S. Cl. 455/414.1

(57) ABSTRACT

An apparatus and method of storing streaming media in a memory associated with a wireless communication device in response to receiving a communication request. A wireless transmission of the media streaming session content can be received at the wireless communication device. The media streaming session content can be played at the wireless communication device while receiving the media streaming session content. A communication request can be received. Subsequent media streaming session content can be stored in a memory associated with the wireless communication device in response to receiving the communication request.

### BACKGROUND

1. Field

The present disclosure is directed to a method and apparatus for storing media during interruption of a media session. More particularly, the present disclosure is directed to storing streaming media in a memory associated with a wireless communication device in response to receiving a communication request.

2. Description of Related Art

Presently, it is anticipated that a wireless network will be able to transmit the same streaming media content to multiple wireless communication devices simultaneously. For example, a wireless network may be able to transmit sporting event broadcasts, movies, or other streaming media content to multiple wireless communication devices. Unfortunately, such a streaming media content transmission does not allow a user to pause or stop a session for access at a later time. This problem can be especially burdensome because a wireless communication device user may receive an incoming communication, such as a call, while receiving streaming media content. Yet, the user cannot answer the call or respond to the communication without missing a portion of the streaming media content while responding. A similar problem exists if the user desires to place a call or engage in any other communication using the wireless communication device while receiving streaming media content.

Thus, there is a need for allowing a user to place a streaming media content session on hold and store the contents of the session while the session is on hold.

### BRIEF DESCRIPTION OF THE DRAWINGS

The embodiments of the present invention will be described with reference to the following figures, wherein like numerals designate like elements, and wherein:

FIG. 1 is an exemplary block diagram of a system according to one embodiment;

FIG. 2 is an exemplary block diagram of a wireless communication device according to one embodiment;

FIG. 3 is an exemplary illustration of a system according to another embodiment;

FIG. 4 is an exemplary illustration of a communication device according to another embodiment;

FIG. 5 is an exemplary illustration of a microprocessor and memory system according to one embodiment; and

FIG. 6 is an exemplary flowchart illustrating the operation of a wireless communication device according to one embodiment.

### DETAILED DESCRIPTION

The disclosure provides an apparatus for and method of storing subsequent streaming media in a memory associated with a wireless communication device in response to receiving a communication request. For example, the disclosure provides for selectively storing at least one media of a multicast or unicast session in a local memory of a wireless communication device when a media streaming session is interrupted by an event, such as an incoming call. A user of the wireless communication device can resume playing the session from the local memory when the interruption ends. The user can also skip portions of the session during playback. Among other benefits, no reverse signaling is required to effect a pause of the session. Furthermore, there is no signaling delay associated with pausing or resuming the session. Also, the user can be signaled during the interruption that memory content is nearly full. Additionally, the user can select a default option to store or not store the session when answering a call. For example, the user can select to store both the video and the audio or just the audio portion of a multimedia session. The user may manually pause and store the session content or may select an option to automatically pause and store session content when receiving, answering, or placing a communication.

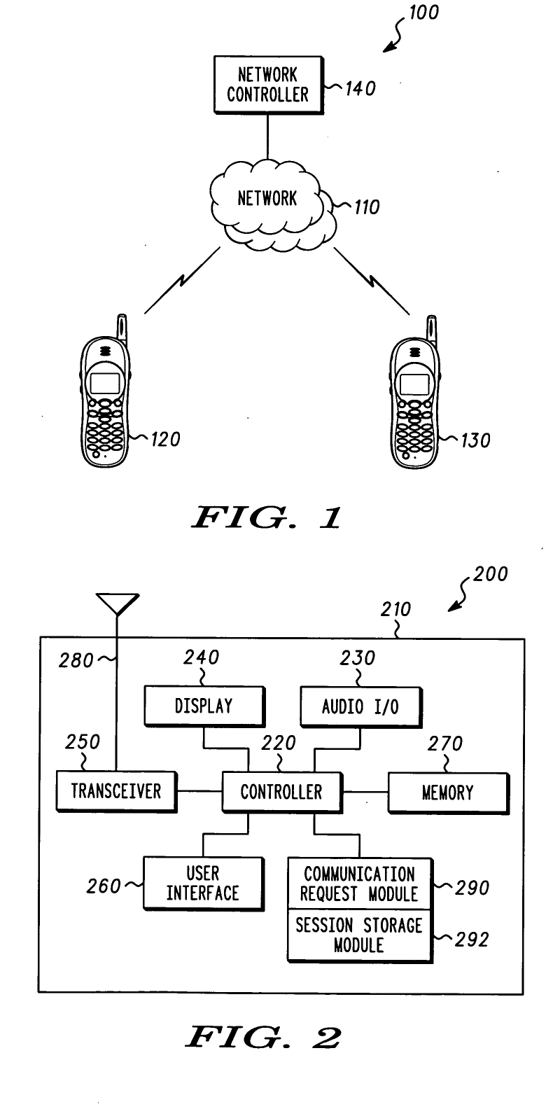

FIG. 1 is an exemplary block diagram of a system 100 according to one embodiment. The system 100 includes a network controller 140, a network 110, and one or more terminals 120 and 130. Terminals 120 and 130 may include telephones, wireless telephones, wired telephones, cellular telephones, PDAs, pagers, personal computers, wireless communication devices, or any other device that is capable of sending and receiving communication signals on a network including wireless network.

In an exemplary embodiment, the network controller 140 is connected to the network 110. The controller 140 may be located at a base station, at a radio network controller, or anywhere else on the network 110. The network 110 may include any type of network that is capable of sending and receiving signals, such as wireless signals and media streaming session content signals. For example, the network 110 may include a wireless telecommunications network, a cellular telephone network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals.

In operation, terminals 120 and 130 can be used to receive media streaming session content signals. For example, a content server located at the network controller 140 can provide media streaming session content signals for sporting events, movies, news programs, or other media signals to subscribed terminals 120 and 130. Also, terminals 120 and 130 can be used to communicate with each other or other wireless or wired communication devices. For example, for one terminal 120 to communicate with another terminal 130, communication signals can be routed through the network 110 and/or the network controller 140.

According to one embodiment, the terminal 120 can receive a wireless transmission of the media streaming session content. The terminal 120 can play the media streaming session content while receiving the media streaming session content. While receiving and playing the media streaming session content, the terminal 120 can receive a communication request. The terminal 120 can then store subsequent media streaming session content in a memory associated with the terminal 120 in response to receiving the communication request. The media streaming session content can be broadcast-multicast service media streaming session content, broadcast media streaming session content, multicast media streaming session content, and/or unicast media streaming session content. The terminal 120 may store only a portion of subsequent media streaming session content in the memory associated with the terminal 120. For example, the terminal 120 can store only an audio portion of subsequent media streaming session content and/or a video portion of subsequent media streaming session content.

For example, the terminal 120 can receive a notification of an incoming call and the communication request can be a user input to answer the incoming call. The communication request can also be a request to originate an outgoing call by the user, a text message, or a request to enter a push-to-talk session. Receiving a communication request can also include receiving a request to enter at least one of a short messaging service session, and enhanced messaging service session, a multimedia messaging service session, an E-Mail session, an instant messaging session, a calendar session, a push data session, or any other session.

Furthermore, the terminal 120 may be configured to automatically subscribe to and receive media streaming session content when the content server located at the network controller 140 starts the media streaming session. For example, a user can schedule a broadcast of a financial report in the terminal's calendar program to automatically start the program at a scheduled program start time. If the terminal 120 is in an ongoing communication session, it can store subsequent media streaming session content in a memory associated with the terminal 120.

While storing subsequent media streaming session content, the terminal 120 can detect a memory limit for storage of the subsequent media streaming session content is about to be exceeded and provide an alert while storing subsequent media streaming session content in the memory associated with the terminal 120, the alert indicating the memory limit for storage of the subsequent media streaming session content is about to be exceeded. The terminal 120 can also store subsequent media streaming session content in the memory associated with the terminal 120 in a compact format if the memory limit for storage of the subsequent media streaming session content is about to be exceeded. The terminal 120 can additionally detect a memory limit for storage of the subsequent media streaming session content has been reached and stop the receiving of subsequent media streaming session content when the memory limit for storage of the subsequent media streaming session content has been reached.

The terminal 120 can suspend playing of the media streaming session content in response to receiving the communication request. The terminal 120 can further resume playing of the stored subsequent media streaming session content from the memory associated with the terminal 120. For example, the terminal 120 can resume playing the stored content when a call is ended, in response to the user requesting resumption of play, or in response to any other useful event. The terminal 120 can also receive an input to skip the playing of at least a portion of the stored subsequent media streaming session content and can skip the playing of at least a portion of the stored subsequent media streaming session content from the memory associated with the terminal 120.

According to another related embodiment, the terminal 120 can receive a wireless transmission of media streaming session content, play the wireless transmission of the media streaming session content, receive a communication request, store subsequent media streaming session content in a memory associated with the terminal 120 in response to receiving a communication request, and manage access control for receiving and storing subsequent media streaming session content. Managing access control can include obtaining session access keys and/or decryption keys. Managing access control can also include obtaining resource allocation parameters. Managing access control can further include obtaining media streaming session content information when moving across transmission boundaries. Managing access control can additionally include registering for access to media streaming session content information when moving across transmission boundaries.

According to another related embodiment, the terminal 120 can receive a wireless transmission of broadcast media streaming session content, play the broadcast media streaming session content while receiving the broadcast media streaming session content, receive a request to enter a call, suspend playing of the media streaming session content in response to receiving the request to enter the call, and store subsequent broadcast media streaming session content in a memory associated with the terminal 120 in response to receiving the request to enter the call.

FIG. 2 is an exemplary block diagram of a wireless communication device 200, such as the terminal 120 or the terminal 130, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The wireless communication device 200 can also include a communication request module 290 and a session storage module 292. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and a electronic device. The memory 270 may include a random access memory, a read only memory, an optical memory, a subscriber identity module memory, or any other memory that can be coupled to a wireless communication device. For example, the memory 270 may be a detachable memory, a wirelessly connected memory, and/or a wired connected memory. The communication request module 290 and the session storage module 292 can be coupled to the controller 220, can reside within the controller 220, can reside within the memory 270, or can be located anywhere else on the wireless device 200. Thus, the communication request module 290 and session storage module 292 can be hardware modules, can be software modules, can be integrated into the components of the wireless communication device 200 and/or can be autonomous modules on the wireless communication device 200.

In operation, the transceiver 250 can include a receiver that receives media streaming session content. The memory 270 can store received media streaming session content. The controller 220 can process received media streaming session content and the display 240 and the audio input and output circuitry 230 can output the session content. The communication request module 290 can recognize a received communication request. The session storage module 292 can store received media streaming session content in the memory 270 in response to the communication request module 290 recognizing the received communication request. The transceiver 250 can also receive a communication signal from another communication device. The media streaming session content can be broadcast media streaming session content. Furthermore, the controller 220 can be configured to perform all of the operations described with respect to the terminal 120 in the system 100.

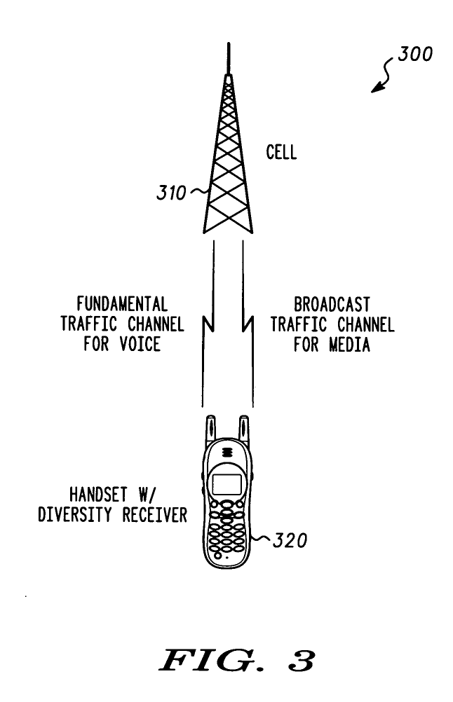

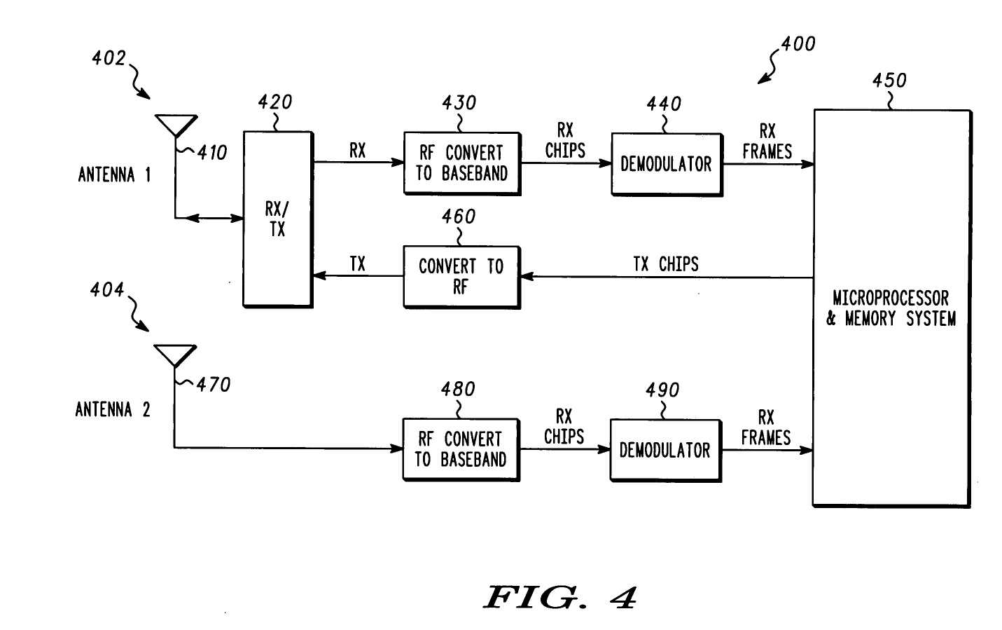

FIG. 3 is an exemplary illustration of a system 300, such as a portion of the system 100, according to another related embodiment. The system 300 can include a cellular base station 310 and a terminal 320. The cellular base station 310 can be a code division multiple access (CDMA) base station, a time division multiple access base station, or any other base station. The terminal 320 can be a wireless communication device, a CDMA handset with a diversity receiver, or any other useful terminal. In operation, the base station 310 can send data to the terminal 320 using different subchannels. There can be many different ways to construct subchannels. For example, subchannels may be different time slots, different frequency bands, different code channels, or the like. Subchannels may also be orthogonal or non-orthogonal. For example, code channels constructed via Walsh codes can be orthogonal at the transmitter, but code channels constructed by other codes, such as PN codes, may not be orthogonal. In a CDMA example, a first Walsh code can carry a CDMA voice call that is intended for the terminal 320. A second Walsh code can carry data on a broadcast channel that can be received by multiple terminals. The terminal 320 can then receive the data on both Walsh codes.

As illustrated in FIG. 2, an alternate embodiment may use only one radio frequency chain. For example, the controller 220 and/or the transceiver may include a demodulator tuned to two different Walsh channels that provides two different output receive frames. Alternatively, there may be multiple parallel demodulators, each tuned to a different Walsh code. A demodulator may include a despreader and a rake receiver, or it may be an advanced demodulator, such as an minimum means squared error receiver. Additionally, a single receiver in a system 100 can despread multicode CDMA or despread control and data channels on different Walsh codes.

FIG. 4 is an exemplary illustration of a communication device 400 such as the terminal 320 or the terminal 120 according to another embodiment. The communication device 400 can include a first transceiver section 402 a second transceiver section 404, and a microprocessor and memory system 450. The first transceiver section 402 can include a first antenna 410, a first transceiver 420, a first radio frequency to baseband conversion module 430, a first demodulator 440, and a radio frequency conversion module 460. The first demodultor 440 can be tuned to a first Walsh code. In operation, the first transceiver section 402 can be used for full duplex communication. The first transceiver section 402 can receive and decode a fundamental traffic channel carrying voice communications on a first Walsh code. The first transceiver section 402 can also transmit back to a base station for uplink voice traffic. The first radio frequency to baseband conversion module 430 can include radio frequency components to convert a radio frequency signal to baseband chips. The first demodulator 440 can convert the chips to frames of data carrying speech. The first demodulator 440 may comprise a despreader and a rake receiver. The first demodulator 440 may also be an advanced demodulator, such as an MMSE receiver, or any other demodulator. The microprocessor and memory system 450 can process the data for output to a user. The microprocessor and memory system 450 can also receive data to be transmitted from a user. The radio frequency conversion module 460 can convert the data to be transmitted to a radio frequency signal for transmission.

The second transceiver section 404 may be only a receiver section. The second transceiver section 404 can include a second antenna 470, a second radio frequency to baseband conversion module 480, and a second demodulator 490. The second demodulator may include a rake receiver, a despreader, an advanced demodulator, or any other demodulator. In operation, the second transceiver section 404 can be used to decode a second Walsh code signal. The second radio frequency to baseband conversion module 480 can convert a radio frequency signal to baseband chips. The second demodulator 490 can convert the chips into frames of data carrying a broadcast signal for processing by the microprocessor and memory system 450. Thus, the first transceiver section 402 can be used for full duplex communications and the second transceiver section 404 can be used for receiving streaming media session content.

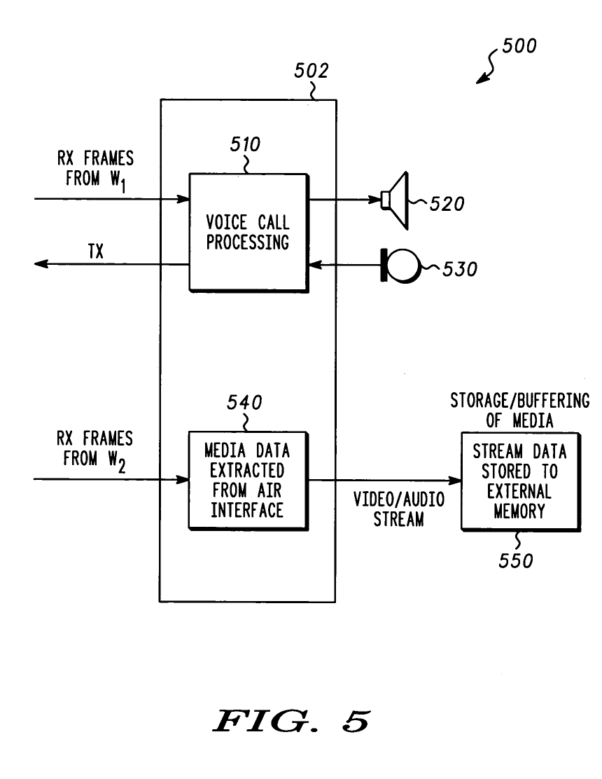

FIG. 5 is an exemplary illustration of a microprocessor and memory system 500, such as the microprocessor and memory system 450, according to another embodiment. The microprocessor and memory system 500 can include a microprocessor 502 having a voice call processing module 510 and a media module 540, a speaker 520, a microphone 530, and a storage module 550. In operation, frames of data from the first transceiver section 402 can be handled by the voice call processing module 510, such as a portion of code running on the microprocessor 502, which handles voice call operations. Frames of data from the second transceiver section 404 can be handled by the media module, such as a second portion of code running on the microprocessor 502. Frames of data from the second transceiver section 404 can be directed to normal audio/video decoding modules when the communication device 400 is not in a call using the first transceiver section 402. When a communication starts on the first transceiver section 402, the data from the second transceiver section 404 can be redirected to storage, such as the storage module 550, where the data is buffered while the communication is handled by a user of the communication device 400.

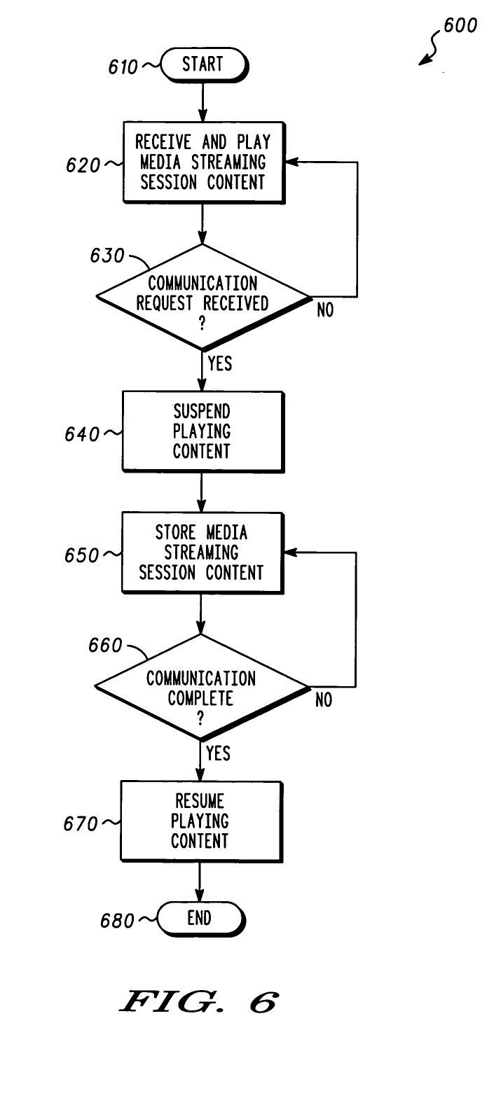

FIG. 6 is an exemplary flowchart 600 illustrating the operation of the wireless communication device 200 according to another embodiment. In step 610, the flowchart begins. In step 620, the wireless communication device 200 can receive and play a wireless transmission of media streaming session content. For example, a user of the wireless communication device 200 can subscribe to a broadcast multicast session program and can start receiving and playing the content. In step 630, the wireless communication device 200 can determine if a communication request has been received. For example, the wireless communication device can receive a notification of an incoming call and can receive a request, such as a user input, to answer the incoming call. As another example, the communication request can be a request to originate an outgoing call, a text message, or a request to enter a push-to-talk session. As a further example, receiving a communication request can include receiving a request to enter a short messaging service session, and enhanced messaging service session, a multimedia messaging service session, an E-Mail session, an instant messaging session, a calendar session, or a push data session. If a communication request has not been received, the mobile communication device 200 can continue receiving and playing the content. If a communication request has been received, in step 640, the mobile communication device 200 can suspend playing the content. In step 650, the mobile communication device 200 can begin storing the media streaming session content in a memory associated with the mobile communication device 200. If a memory limit is about to be exceeded when storing the content, the mobile communication device 200 can initiate various procedures. For example, the mobile communication device 200 can provide an alert that the memory limit is about to be exceeded. The mobile communication device 200 can also begin storing the content in a compact format, such as a compressed format. The mobile communication device 200 can additionally stop receiving or stop storing the content once the memory limit is exceeded.

In step 660, the mobile communication device 200 can determine if the communication initiated with the communication request is complete. If not, the mobile communication device 200 can continue storing the media streaming session content. If the communication is complete, in step 670, the mobile communication device 200 can resume playing the content. The mobile communication device may continue storing the media streaming session content in a memory associated with the mobile communication device 200. When playing resumes, the mobile communication device 200 can allow a user of the mobile communication device 200 to skip portions of the stored content to catch up to the actual transmission of the content. In step 680, the flowchart 600 ends.

The method of this invention is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

1. A method of operating media streaming session content on a wireless communication device, the method comprising:
receiving a wireless transmission of the media streaming session content at the wireless communication device;
playing the media streaming session content at the wireless communication device while receiving the media streaming session content;
receiving a communication request; and
storing subsequent media streaming session content in a memory associated with the wireless communication device in response to receiving the communication request.

2. The method according to claim 1, further comprising:
receiving a notification of an incoming call,
wherein receiving a communication request further comprises receiving a request to answer the incoming call.

3. The method according to claim 1, wherein the communication request comprises at least one of a request to originate an outgoing call, a text message, and a request to enter a push-to-talk session.

4. The method according to claim 1, wherein receiving a communication request further comprises receiving a request to enter at least one of a short messaging service session, and enhanced messaging service session, a multimedia messaging service session, an E-Mail session, an instant messaging session, a calendar session, and a push data session.

5. The method according to claim 1, further comprising suspending playing of the media streaming session content in response to receiving the communication request.

6. The method according to claim 1, further comprising resuming playing of the stored subsequent media streaming session content from the memory associated with the wireless communication device.

7. The method according to claim 6, further comprising:
receiving an input to skip the playing of at least a portion of the stored subsequent media streaming session content; and
skipping the playing of at least a portion of the stored subsequent media streaming session content from the memory associated with the wireless communication device.

8. The method according to claim 1, wherein the media streaming session content comprises at least one of broadcast-multicast service media streaming session content, broadcast media streaming session content, multicast media streaming session content, and unicast media streaming session content.

9. The method according to claim 1, further comprising
detecting a memory limit for storage of the subsequent media streaming session content is about to be exceeded; and
providing an alert while storing subsequent media streaming session content in a memory associated with the wireless communication device, the alert indicating the memory limit for storage of the subsequent media streaming session content is about to be exceeded.

10. The method according to claim 1, further comprising
detecting a memory limit for storage of the subsequent media streaming session content is about to be exceeded; and
storing subsequent media streaming session content in the memory associated with the wireless communication device in a compact format when the memory limit for storage of the subsequent media streaming session content is about to be exceeded.

11. The method according to claim 1, further comprising
detecting a memory limit for storage of the subsequent media streaming session content has been reached; and
stopping the receiving of subsequent media streaming session content when the memory limit for storage of the subsequent media streaming session content has been reached.

12. The method according to claim 1, wherein storing subsequent media streaming session content in the memory associated with the wireless communication device in response to receiving a communication request further comprises storing only a portion of subsequent media streaming session content in the memory associated with the wireless communication device.

13. The method according to claim 12, wherein the portion of subsequent media streaming session content further comprises one of an audio portion of subsequent media streaming session content and a video portion of subsequent media streaming session content.

14. The method according to claim 1, wherein storing subsequent media streaming session content further comprises storing subsequent media streaming session content in at least one of a wireless communication device memory, a detachable memory, a wirelessly connected memory, and a wired connected memory.

15. A method of operating media streaming session content on a wireless communication device, the method comprising:
receiving a wireless transmission of the media streaming session content at the wireless communication device;
playing the wireless transmission of the media streaming session content at the wireless communication device;
receiving a communication request;
storing subsequent media streaming session content in a memory associated with the wireless communication device in response to receiving a communication request; and
managing access control for receiving and storing subsequent media streaming session content.

16. The method according to claim 15, wherein managing access control further comprises obtaining at least one of session access keys and decryption keys.

17. The method according to claim 15, wherein managing access control further comprises obtaining resource allocation parameters.

18. The method according to claim 15, wherein a managing access control further comprises obtaining media streaming session content information when moving across transmission boundaries.

19. The method according to claim 15, wherein a managing access control further comprises registering for access to media streaming session content information when moving across transmission boundaries.

20. A method of operating broadcast media streaming session content on a wireless communication device, the method comprising:
receiving a wireless transmission of the broadcast media streaming session content at the wireless communication device;
playing the broadcast media streaming session content at the wireless communication device while receiving the broadcast media streaming session content;
receiving a request to enter a call;
suspending playing of the media streaming session content in response to receiving the request to enter the call; and
storing subsequent broadcast media streaming session content in a memory associated with the wireless communication device in response to receiving the request to enter the call.

21. A wireless communication device comprising:
a receiver configured to receive media streaming session content;
a memory configured to store received media streaming session content; and
a controller configured to process received media streaming session content, the controller including a communication request module configured to recognize a received communication request, the controller also including a session storage module configured to store received media streaming session content in the memory in response to the communication request module recognizing the received communication request.

22. The wireless communication device according to claim 21 wherein the receiver is further configured to receive a communication signal from another communication device.

23. The wireless communication device according to claim 21 further comprising another receiver configured to receive a communication signal from another communication device.

24. The wireless communication device according to claim 21 wherein the media streaming session content comprises broadcast media streaming session content.

25. The wireless communication device according to claim 21 wherein the memory comprises at least one of a wireless communication device memory, a detachable memory, a wirelessly connected memory, and a wired connected memory.

26. A method of operating media streaming session content on a wireless communication device, the method comprising:
entering an ongoing communication at the wireless communication device;
receiving a wireless transmission of the media streaming session content at the wireless communication device while in the ongoing communication at the wireless communication device; and
storing subsequent media streaming session content in a memory associated with the wireless communication device in response to receiving the communication request.

27. The method according to claim 26, further comprising:
ending the ongoing communication; and
playing the stored media streaming session content at the wireless communication device after ending the ongoing communication.

28. The method according to claim 27, wherein playing the stored media streaming session content at the wireless communication device further comprises playing the stored media streaming session content at the wireless communication device while receiving additional media streaming session content.
